(19) United States
(12) Patent Application Publication
(10) Pub. No.: US 2014/0200041 A1
(43) Pub. Date: Jul. 17, 2014

(54) EVALUATION OF OVERALL PERFORMANCE OF INTERACTIVE APPLICATION SERVICE

(71) Applicants: Otso Juntunen, Enebyberg (SE); Ville Sarja, Helsinki (FI)

(72) Inventors: Otso Juntunen, Enebyberg (SE); Ville Sarja, Helsinki (FI)

(73) Assignee: HEADLONG OY, Espoo (FI)

(21) Appl. No.: 14/124,774

(22) PCT Filed: Jun. 13, 2012
(86) PCT No.: PCT/FI2012/050590

§ 371 Date: Feb. 25, 2014

(30) Foreign Application Priority Data
Jun. 14, 2011 (FI) 20115585

(51) Int. Cl. H04W 12/08; H04W 4/14

(52) U.S. Cl. CPC H04W 12/08; H04W 4/14
USPC 455/466

(57) ABSTRACT

A performance monitoring system In which a test apparatus sends a test message of a non-realtime messaging service. The test message is formatted for a defined interactive application service. The test apparatus determines content of an expected reply message; the relationship between the content of the expected reply message and the content of the test message corresponds directly with service logic of the defined interactive application service. The test apparatus uses a predefined matching criterion to compare contents of received messages of the non-realtime messaging service to contents of the expected reply message and identifies a received message as an associated message If the matching criterion Is met. The associated message is used to generate a measurement indication for evaluation of current overall performance of the defined interactive application service.

### FIELD OF THE INVENTION

The present invention relates to communications and especially to a method, a test apparatus, a control apparatus, a system and a computer program product for evaluating overall performance of interactive application services, as defined in the preambles of independent claims 1, 12, 13, 15 and 16.

### BACKGROUND OF THE INVENTION

In communications, systems apply protocols that provide predefined formats for exchanging messages. Use of protocols means that each message from a transmitting peer entity has an identifiable meaning and is intended to trigger a defined response in a receiving peer entity.

Successful exchange of information between peer entities requires successful delivery of a message from a first peer entity to a second peer entity and successful delivery of a response message from the second peer entity to the first peer entity. In protocol-based transmissions the interaction between the first message and the second message are immediate, or at least the reply mechanism is precisely defined. Due to this, a delay between transmission of the first message and reception of the second message can be accurately estimated and, consequently, success or failure of such exchange of information may be easily monitored. If the delay is longer than the estimated delay, there is evidently a problem in delivery and failure can be indicated.

However, in some message delivery mechanisms, the delay between transmission of the first message and reception of the second message is not solely dependent on performance of the entities delivering the messages. Some message delivery services involve an intermediate node in which a transmitted message may be stored, and the message is forwarded to the receiving endpoint only when a specific forwarding condition is met.

For example, delivery of short messages in mobile communications networks involves an intermediate short message service centre in which a message is stored until a receiving subscriber is able to receive the message. The delay between transmission of the first message and reception of the second message thus depends on availability of a subscriber for communications. Under such circumstances measuring success or failure in exchange of information based on transmission delays only would be incorrect. Measurement results derived this way would mainly depend on subscriber behaviour, not on performance of the service, as such.

Interactive application service refers here to data processing service that is hosted in a communications node accessible to other nodes via one or more communications interfaces. In operations of the interactive application service, one node operates as a serving node that provides resources to implement service logic specific for the interactive application service, and another node operates as a served node. A served node sends to the serving network node a first message that includes first information, and the serving node processes the first information according to the service logic. Processing of the first information with the service logic generates second information that the serving node includes in a second message and sends back to the served node.

Overall performance of an interactive application service refers to the capability of all the elements involved in provision of the interactive application service to jointly operate according to technical characteristics defined for the interactive application service. Technical characteristic is a feature that may be configured with technical means between the first message and the second message and technical features related to overall performance can be determined on the basis of properties of the first message and the second message. Examples of a technical characteristic that may be defined for an interactive application service comprise round-trip delivery time of the service, and the extent to which the second message complies with the predefined service logic of the interactive application service. The technical characteristics do not involve user's perception of the content of the interactive application as such. For example, a personal opinion about how well a daily horoscope or betting tips fulfilled the user's subjective expectations are not technical characteristics, and are not applicable for evaluating overall performance of the interactive application service that provides the horoscope and the betting tips.

Interactive application services may be implemented on messaging technologies where exchange of information involves an intermediate node that adds to message delivery an unforeseeable delay component. In addition, acknowledgement messages provided by protocols of the messaging service are typically available to a transmitting node only. To measure success or failure of a two-way communication, acknowledgement messages from both communicating endpoints should be available for the one endpoint. Due to this, it has not been possible to efficiently monitor performance of this type of interactive application services. So far, they have been monitored and evaluated by collecting user opinions and making random manual checks. Collection of measurement information and manual processing of collected results this way is, however, too laborious and expensive for any industrially feasible applications.

### BRIEF DESCRIPTION OF THE INVENTION

The object of the present invention is to provide a method and apparatus so as to overcome at least some of the prior art disadvantages. The objects of the present invention are achieved with a method according to the characterizing portion of claim 1. The objects of the present invention are further achieved with an apparatus according to the characterizing portion of claims 12, 13, and with a computer program product according to the characterizing portion of claim 16.

The preferred embodiments of the invention are disclosed in the dependent claims.

The present invention is based on the idea of making the measurements using a special-purpose test agent that sends test messages to a measured interactive service application and is aware of the contents of the expected reply messages by the service. An incoming message is associated with the test message if its contents match with the contents of the expected reply message. The associated message can then be used to determine a measurement indication that is directly suitable for evaluations regarding the overall performance of the interactive application service.

The present invention has the advantage that it allows evaluation of current overall performance of an interactive application service even if one can operate in one endpoint of the system only.

### BRIEF DESCRIPTION OF THE FIGURES

In the following the invention will be described in greater detail, in connection with preferred embodiments, with reference to the attached drawings, in which

FIG. 1 illustrates entities of a non-realtime messaging service;

FIG. 2 illustrates a system configuration for evaluation of overall system performance of an interactive application service;

FIG. 3 illustrates steps of a method implemented in a test agent; and

FIG. 4 illustrates configuration of an exemplary apparatus.

### DETAILED DESCRIPTION OF SOME EMBODIMENTS

The following embodiments are exemplary. Although the specification may refer to “an”, “one”, or “some” embodiment(s), this does not necessarily mean that each such reference is to the same embodiment(s), or that the feature only applies to a single embodiment. Single features of different embodiments may be combined to provide further embodiments.

Features of the invention will be described with simple examples of a system architecture in which various embodiments of the invention may be implemented. Only elements relevant for illustrating the embodiments are described in detail. Various implementations of the invented methods and devices comprise elements that are generally known to a person skilled in the art and may not be specifically described herein.

In the embodiments, the first and second messages of an interactive application service are conveyed using a non-realtime messaging service. The block chart of FIG. 1 illustrates entities of a non-realtime messaging service and delivery of messages between these entities. The non-realtime message service refers here to a messaging service where delivery of a message from a first node 10 to a second node 12 is made in two separate legs via an intermediate node 14. In the first leg, a first message transmitted from the first node 10 to the intermediate node 14 and stored there. The first message is forwarded in the second leg from the intermediate node 14 to the second node 12 when the second node 12 is ready to receive the message.

Readiness to receive a message manifests differently, according to the type of non-realtime messaging service applied for the message transmission. The description of embodiments of the invention use Short Message Service (SMS) and Multimedia Messaging Service (MMS) as examples of non-realtime messaging service. Both these technologies are extensively documented and well known by people skilled in the art. It is, however, noted that the scope of protection is not restricted to these exemplary messaging services but cover any present and future messaging service technologies where delivery of messages takes place via an intermediate node as described above.

SMS according to GSM (Global System for Mobile Communications) allows exchange of short text messages between terminal endpoints N1 and N2. In SMS, the second node 12 readiness to receive a message is related to availability of the terminating endpoint N2 for communication. The originating endpoint N1 10 stores an address of a Short Message Service Centre (SMSC) that acts as the intermediate node 14. When N1 sends a short message to another node N2, N1 includes to the short message also the stored address of the SMSC, and the short message is not delivered directly to the destination address, but to the SMSC. If the delivery is successful, the short message is stored in the SMSC for subsequent delivery.

SMSC retrieves routing information of N2 to deliver the short message to its destination. In the course of this, N2 is paged and if the page is successful, SMSC sends the short message to N2. If the delivery is successful, the delivered message will be removed from store and forward processes of the SMSC, and delivery is acknowledged to N1. If the page or delivery fails, the SMSC invokes a retry procedure that periodically makes further attempts to deliver the short message.

In addition, the mobility management procedures of the applied network may provide an alerting link 16 by means of which readiness of N2 to receive the short message may be monitored. The SMSC may request home location register (HLR) of N2 to be notified when N2 becomes available again. In response to the SMSC request, the HLR will set a flag against N2 account, indicating that N2 is unavailable for short message delivery, and store the address comprising the SMSC in a Message Waiting Data (MWD) list for N2. The indication about availability for short message delivery may arrive to HLR in various ways, depending on the flag in question. If N2 has been detached from the network, HLR is informed about a location update attempt of N2. On the other hand, if N2 is out of coverage, it does not answer to page attempts by a Visitor Location Register. When N2 returns to coverage, it responds to VLR page, and VLR informs HLR about this. If N2 has been unavailable for short message delivery because its memory is full, VLR monitors this situation and informs HLR when the memory capacity is no longer exceeded. Upon receipt of an indication that N2 is ready to receive short message, HLR informs the SMSC in the MWD, and the informed SMSC attempts to deliver the short message again.

The Multimedia Messaging service (MMS) allows delivery of messages that include multimedia content. Contrary to the SMS, in MMS, readiness to receive a message is indicated explicitly by the terminating endpoint N2. The multimedia message is created in N1; the format of binary MMS message files is according to the MMS Encapsulation Protocol specification published by the Open Mobile Alliance (OMA). The encoded binary MMS message file is delivered to a store-and-forward web server MMSC that acts as the intermediate node 14. A subset of the binary MMS header is sent as an MMS notification message via SMS to N2 together with a URL pointer to the location of the complete message. When this MMS notification message is received by N2, it automatically initiates a gateway connection to download the content of the MMS message. If N2 is not MMS capable, the message is usually delivered to a web based service from where the content can be viewed from a normal Internet browser.

Accordingly, overall performance of an interactive application service that applies non-realtime messaging service is basically a result of four legs that are not mutually synchronized. Let us consider a SMS-based interactive application service where N1 sends a first message to N2 and N2 replies by transmitting a second message to N1. The first and second messages are only related by the service logic implemented in N2, there is no protocol that would link them together. Protocols of SMS service Inform N1 when the first message is delivered to IN and to N2 and, correspondingly, N2 is informed when the second message is delivered to IN and N1. Overall performance of the interactive application service is, however, based on success and/or failure of delivery both of these messages, and ability of N2 to perform the service logic that justifies the sale of the service as commodity. Evaluation of the overall performance based on these conventional message delivery acknowledgement procedures would require full availability to messages and signalling in both endpoints.

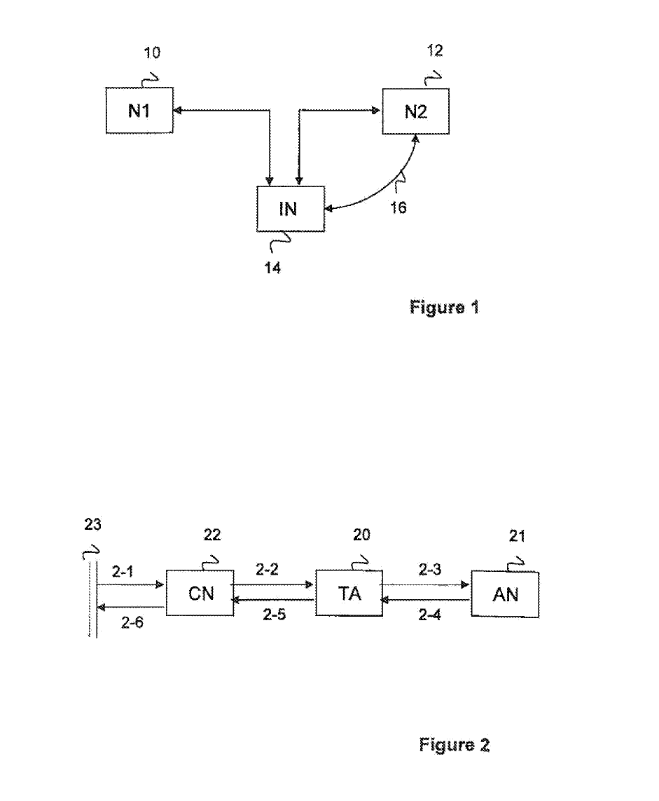

FIG. 2 illustrates a system configuration that facilitates efficient evaluation of overall system performance of an interactive application service. The system comprises a test agent 20, an application node 21 and a control element 22. It is noted that the elements shown in FIG. 2 are logical elements that represent grouped functions that may be implemented in one or more operatively interconnected physical units.

A test agent 20 is a special-purpose computer apparatus that comprises a messaging interface for communicating with the application node 21 with messages of a non-realtime messaging service. The test agent 20 may thus operate as a served node of an interactive application service provided by the application node 21. The test agent 20 comprises also a control interface for communicating with the control element 22. The test agent and the control node may co-exist in one physical device, or the test agent may be a remote device. If the test agent and the control device are implemented in the same physical device, the control interface comprises one or more of the internal interfaces of the device. A remote test agent may be configured to communicate over one or more defined fixed or mobile networks. Messaging interface and control interface of a remote test agent may apply the same or different technology, depending on the applied configuration.

One interesting monitored aspect is the effect of location of the served node to the results in overall performance of an interactive application services. Accordingly, in the following an exemplary embodiment of a mobile test agent monitoring overall performance of a SMS-based application service is described in more detail. Embodiments of the invention may, however, apply other types of test agents and non-realtime services.

The application node 21 is a computer apparatus that comprises a messaging interface for communicating with external nodes over non-realtime messaging service. The application node is configured to input Information via the messaging interface, process the input information with specific application logic to generate result information, and output the result information to be forwarded to the external node via the messaging interface.

The control node 22 is also a computer apparatus that comprises a control interface for communicating with the test agent 20. The control node 22 comprises also an operator interface 23 for communicating with parties requesting measurements. The operator interface may be a web page accessible to a plurality of external nodes. Alternatively, access to the control node may be moderated by an intermediate operator unit of the control node that generates and authorizes measurement events as a result of requests it receives from external nodes.

A measurement event relates to one interactive application service and may comprise a number of measurement tasks. As an example, let us assume that the interactive application service in question is automatic directory enquiry service. In the example, one directory record includes at least subscriber number data and subscriber identification data of one subscriber. According to the service logic, when a served node sends a short message including information that matches with either of the data fields of a record, the serving node generates a message that carries subscriber number data and subscriber identification data of that record back to the served node.

In the embodiment, the control element 22 receives (step 2-1) via the operator interface 23 a request to measure overall performance of the directory enquiry service. The request identifies the measured service and advantageously includes other parameters for controlling the execution of the measurement, for example the measurement period, area in which the tests should be made, etc. The control element uses information in the request to create a measurement event. A measurement event comprises a defined sequence of test messages to be used in the measurement.

Information for test messages and/or expected reply messages can be generated in the control element 22 or in the test agent 20, depending on which element has the knowledge of the service logic of the measured interactive application service and format of short messages used in it. For example, in the case of the directory enquiry service, service logic may be known to the control node 22 but not to the test agent 20. In this case, information for test messages and corresponding content of the expected reply messages is generated in the control element 22, and forwarded to the test agent 20 when a measurement event is triggered. On the other hand, the service logic may be available to the test agent 20 such that it can independently determine content of expected reply messages when it receives information to be included in the test messages. Alternatively, the test agent may even be configured to both generate test information to be included in the test messages and determine content of expected reply messages.

In the exemplary case of directory enquiry service, let us assume that an external party requests measured information on overall performance of the service within a defined area and during a defined time period. Let us assume also that the external party submits the request via a form in a web page and completion of the form generates a measurement event for the service. In the example, the test agent is mobile and the service logic and generation of the test messages as well as the content of the expected reply messages is performed in the control node. The control node provides triggering information (step 2-2) to the test agent that initiates the measurement event. Triggering information comprises test data in form of a group of subscriber data blocks to be included in test messages. The triggering information comprises also content of directory entries of the records that match with the test data. In addition, the triggering information also comprises information for identifying the measured interactive application service. Other measurement parameters may be provided by the control node, as well.

In this example, the test agent generates the actual test messages. Each test message may be specifically formatted for the interactive application service. Destination address of the test message typically identifies a provider of the interactive application service, and the service itself may be identified in the content of the test message. For example, the directory enquiry service may be one service in a cluster of services provided by an application node addressed with number ‘123456’. The service-related data may be included in the content of the test message and different types of information may be separated from each other by appropriate formatting of the content of the short message. For example, the directory enquiry service may be identified with a defined text string ‘search’ in the beginning of the content of the test message, and the one or more data blocks used for the search and matching may be separated from the text string with spaces. Accordingly, test event for measuring overall performance of the directory enquiry service could comprise a test task: delivery of a test message that is addressed to number ‘123456’ and carries a payload ‘search john doe helsinki’. According to the service logic, the payload of a corresponding expected reply message will then comprise directory information related to subscribers whose identification data fields comprise text strings ‘john’, ‘doe’, and ‘helsinki’. As an example, let us consider that the expected reply message comprises first directory entry ‘John Doe, Isopaankatu 3B, 00567 Helsinki, +358-9-999999’. One test message may also correspond to further expected reply messages, so let us assume that the expected reply message comprises also a second directory entry ‘John Doe, Harsokatu 3B, 00765 Helsinki, +358-9-999999’.

A test task involves delivery of a test message from the test agent to the application node (step 2-3), delivery of one or more expected reply messages from the application node to the test agent (step 2-4), and detection of one or more associated messages in the test agent. An associated message is a reply message sent by the serving node in response to a received test message. As discussed earlier, the test message and the reply message are related by means of the service logic, but from the transmission protocol point of view, the test message and the reply message are independent entities that do not carry explicit pointers to each other. Due to this asynchronous nature of interactive application services, a test agent needs a special arrangement to associate an incoming reply message to a specific test message. In the present embodiments, this is accomplished with a predefined matching criterion that is applied to the content of incoming messages. If the content of the incoming message fulfils the matching criterion, the incoming message is considered to be an associated message.

The matching criterion is used as a test to indicate whether an incoming message is a true response to the test message. In the easiest case transmissions in every four legs has been completely successful and the application node has determined the second information perfectly. This may not, however, always be the case. A message received by the test agent may be a reply message to a previously or later sent test message. It is also possible that a transmission error has occurred on one of the legs to the application node such that the test data block received by the application node is different that the test data block sent by the test agent. In such a case, the reply does no longer carry the expected information. Transmission errors that contort the content of the messages can also take place in the return leg. In addition, it is possible, that the application node does not perform appropriately so that the incoming message does not carry information according to the service logic.

Matching criterion is a rule that may be applied in connection with any test message. In order to detect an associated message of a test message, the test agent determines content of the expected reply message and compares it with content of a received message. If the matching criterion is met, the incoming message is considered to be an associated message. For example, in the case of the directory enquiry service, the matching criterion may be considered to be met if an incoming message comprises both of the subscriber identification data blocks ‘John’, ‘Doe’. Match with other fields, like ‘Helsinki’, do not fulfil the criterion. Thus an incoming message carrying information like “A data entry for the requested search term ‘john doe helsinki’ was not found” could be associated to the test message even is the content of the incoming message does not literally correspond with the expected result. On the other hand, completely contorted messages will not be associated with the test message, and will show as failed transmissions.

The matching criterion is typically service-specific and matches directly with the service logic. Typically the element that has the knowledge about the service logic and generates the test data blocks also provides the matching criterion for detection of associated messages.

The detected associated message may then be used to determine a measurement indication that enables evaluation of current overall performance of the interactive application service. A characteristic of the associated message used for determining the measurement indication may vary depending on the application. For example, information on whether a service request is answered or remains unanswered provides a relevant indication of overall performance. A measurement event can be performed by sending a sequence of test messages and counting associated messages detected in the test agent. The ratio between the number of detected associated messages and the number of transmitted test messages can be used to evaluate overall performance of the interactive application service.

Another measurement indication may be based on duration of the test event. Such measurement indication may be generated by extracting timestamps from a test message and its associated message. The time interval between these timestamps provides a measurement indication on round-trip delivery time of the interactive application service.

More informative measurement indications may be provided by analysing in more detail a level of compliance between the content of the associated message and the content of the expected reply message. The test agent may comprise a second matching criterion that is applied in a further comparison between the contents of an associated message and the contents of the expected reply message. For example, in the case of directory enquiry service, the second matching criterion may test how many of the data blocks of the expected reply message are included in the associated message. In our exemplary test task, a reply message was expected to carry information:

### ‘John Doe, Isopaankatu 3B, 00567 Helsinki, +358-9-999999’

The data blocks in an expected reply message would thus comprise:

[firstname][surname][streetaddress][postcode][city].

If an incoming message carries information

### ‘John Doe, Isopaankatu 3B, 00567 Helsinki, +358-9-998999’

it is detected as an associated message and in a simple analysis would show as a successful test task. However, from the user's point of view the service actually did not perform well at all, because the returned telephone number is wrong. In a more detailed analysis, data blocks of the expected reply message could be compared one by one and the number of fully complying data blocks can be used as a measurement indication of overall performance of the interactive application service.

An even more detailed indication may be provided by using a position-based indication [11110] for each of the data blocks in the expected reply message. By means of this, the nature of failed content could be identified in evaluations and different types of failures could be weighted differently. For example, in the exemplary case, a failure in the first name of the subscriber may be considered less damaging as a failure in telephone number of the subscriber. Thus a measurement indication [11110] for associated message ‘John Doe, Isopaankatu 3B, 00567 Helsinki, +358-9-998999’ could be considered to indicate FAIL with weight FAIL*4 whereas a measurement indication [01111] for associated message ‘Joe Doe, Isopaankatu 3B, 00567 Helsinki, +358-9-999999’ could be considered to indicate FAIL with weight FAIL*1 only.

It is noted that these examples are illustrative only, on the basis of the description provided above, various matching criteria may be developed for various types of interactive application services without deviating from the scope of protection. For example, the application node may provide a mobile currency conversion service where the served node provides a conversion request by sending a message carrying data blocks ‘[value][converted from][converted to]’. The matching criterion may be considered to be met if data fields in the [converted from] and [converted to] fields of an incoming message comprises both the same information as in the expected reply message. Basic measurement indication may again be based on the ratio between currency conversion requests and associated replies. For more detailed evaluation, a measurement indication may further indicate the difference between values in the [value] data clocks of the associated message and the expected reply message.

The test agent may also complement measurement indications with measurement-related metadata. For example, the test agent may record its position when it sends the test message and/or when it receives the associated message, and add these recorded positions to the measurement indication. This measurement-related metadata may be applied to analyse further aspects and dependencies of the interactive service. For example, position-based metadata enables analysing dependency of overall performance of the interactive application service on the location of the served node. Other types of metadata, like timestamps, serving cell identity, etc. may be applied.

In the present embodiment, the test agent provides (step 2-5) the generated measurement indications to the control node. The control node may provide (step 2-6) the measurement indications directly to the external node that requested the measurement. The control node may also further process the received information, and provide the results to the requester in a processed form.

By means of the proposed procedure it is possible to generate automatically a concrete measurement indication that allows evaluation of current overall performance of an interactive application service even if one can only operate in the served node end of the system. This facilitates dynamic overall performance monitoring of interactive application services, which due to the asynchronic nature of the delivery processes has not been available before. Both the test events and the measurement indications are generated in a form that may be easily enhanced to increase the level of detail of the evaluations.

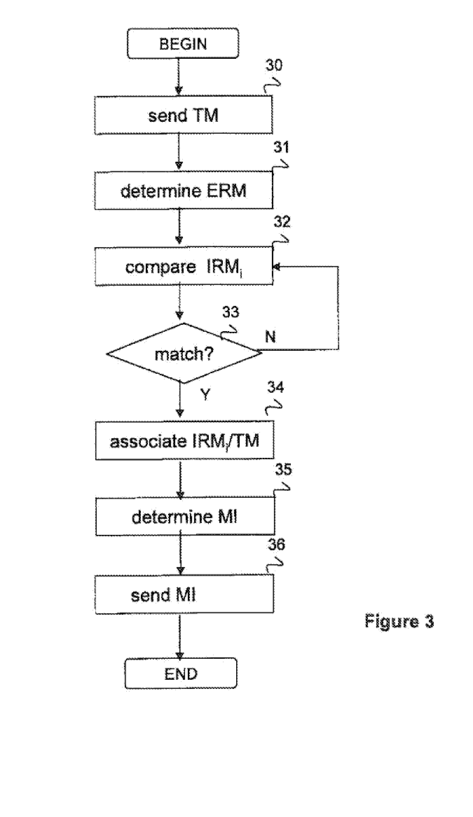

FIG. 3 illustrates steps of a method implemented in a test agent of the system described in FIG. 2. The steps relate to implementation of one test task. These steps may be multiplied by a person skilled in the art to implementation of a test event formed of a sequence of such test tasks.

The procedure begins when the test agent is switched on and has a connection to the application node. The test agent has received or generated test data blocks to be used in the test task. The test agent includes the test data blocks into a message of a non-realtime messaging service. This is a test message TM that carries the data blocks as payload and is formatted for delivery over the non-realtime messaging service. The test agent sends (stage 30) the test message TM to the application node.

Before, at or after sending the test message, the test agent determines (step 31) content of an expected reply message ERM. The relationship between the content of the expected reply message and the content of the test message corresponds directly with service logic of the defined application service.

After sending the test message, the test agent begins to monitor incoming reply messages IRMi and checks whether one of them could be a reply message, transmitted by the application server in response to the test message. Evidently non-relevant messages may be filtered out by means of information provided by the protocols of the non-realtime messaging service. For example, incoming messages from other addresses than the application node may be filtered out. The potential reply messages are identified by comparing (step 32) contents of received messages of the non-realtime messaging service to contents of the expected reply message. A matching criterion specific for the evaluated interactive application service may be used to test the level of match between the contents.

If the criterion is met (step 33), a received message is identified as an associated message (step 34), which means that the received message is assumed to be a reply message successfully received in response to the earlier transmitted test message.

The associated message may then be used to determine (step 35) a measurement indication MI for evaluation of current overall performance of the defined application service. Characteristics of the associated message can be used as a basis for a measurement indication. For example, existence of the associated message may be used as an indication that a response is received and the two-way exchange of information is thus successfully performed. Protocol data unit or contents of the associated message may also be compared in more detail with corresponding elements the test message or the expected reply message to evaluate various aspects of the overall performance of the interactive service application.

The one or more determined measurement indications MI may then be transferred (step 36) to a control node for delivery to a party that requested the measurement event.

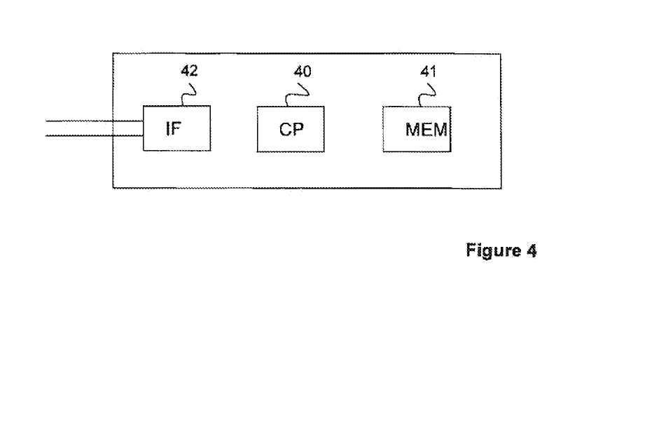

Embodiments of this invention comprise an apparatus, applicable as a test agent or as a control node. The apparatus provides means for implementing the above mentioned methods. FIG. 4 shows a block diagram illustrating configuration of an exemplary apparatus for the purpose. It is noted that any type of user terminals may be applied without deviating from the scope of protection.

The apparatus comprises a processor unit 40 for performing systematic execution of operations upon data. The processor unit 40 is an element that essentially comprises one or more arithmetic logic units, a number of special registers and control circuits. Memory unit 41 provides a data medium where computer-readable data or programs, or user data can be stored. The memory unit is connected to the processor unit 40. The memory unit 41 typically comprises volatile or non-volatile memory, for example EEPROM, ROM, PROM, RAM, DRAM, SRAM, firmware, programmable logic, etc. The apparatus also comprises an interface unit 42 with at least one input unit for inputting data to the internal processes of the apparatus and at least one output unit for outputting data from the internal processes of the apparatus.

If a line interface is applied, the interface unit 42 typically comprises plug-in units acting as a gateway for information delivered to its external connection points and for information fed to the lines connected to its external connection points. If a radio interface is applied, the interface unit 42 typically comprises a radio transceiver unit, which includes a transmitter and a receiver, and is also electrically connected to the processing unit 40. The transmitter of the radio transceiver unit receives a bitstream from the processing unit 40, and converts it to a radio signal for transmission by the antenna. Correspondingly, the radio signals received by the antenna are led to the receiver of the radio transceiver unit, which converts the radio signal into a bitstream that is forwarded for further processing to the processing unit 40. Different radio interfaces may be implemented with one radio transceiver unit, or separate radio transceiver units may be provided for the different radio interfaces.

The interface unit 42 of the apparatus may also comprise a user interface with a keypad, a touch screen, a microphone, and equals for inputting data and a screen, a touch screen, a loudspeaker, and equals for outputting data. The processor unit 40, the memory unit 41, and the interface unit 42 are electrically interconnected to provide means for performing systematic execution of operations on the received and/or stored data according to predefined, essentially programmed processes of the apparatus. These operations comprise the procedures described for the control node and the test agent.

In general, various embodiments of the apparatus may be implemented in hardware or special purpose circuits, software, logic or any combination thereof. Some aspects may be implemented in hardware, while some other aspects may be implemented in firmware or software, which may be executed by a controller, microprocessor or other computing device. Software routines, which are also called as program products, are articles of manufacture and can be stored in any apparatus-readable data storage medium and they include program instructions to perform particular tasks. The exemplary embodiments of this invention also provide a computer program product, readable by a computer and encoding instructions for executing a process for measuring overall performance of interactive application services in the apparatus of FIG. 4.

While various aspects of the invention may be illustrated and described as block diagrams, message flow diagrams, flow charts and logic flow diagrams, or using some other pictorial representation, it is well understood that the illustrated units, blocks, apparatus, system elements, procedures and methods may be implemented in, for example, hardware, software, firmware, special purpose circuits or logic, a computing device or some combination thereof.

It is apparent to a person skilled in the art that as technology advances, the basic idea of the invention can be implemented in various ways. The invention and its embodiments are therefore not restricted to the above examples, but they may vary within the scope of the claims.

1. A method for a test apparatus, comprising:
sending a test message of a non-realtime messaging service, the test message being formatted for a defined interactive application service implemented on the non-realtime messaging service;
determining content of an expected reply message, the relationship between the content of the expected reply message and the content of the test message corresponding directly with service logic of the defined interactive application service;
using a predefined matching criterion to compare contents of received messages of the non-realtime messaging service to contents of the expected reply message;
identifying a received message as an associated message if the matching criterion is met;
using the associated message to generate a measurement indication for evaluation of current overall performance of the defined interactive application service.

2. A method according to claim 1, characterized by
performing a test event comprising one or more test tasks, one test task including sending of a test message and generation of a measurement indication based on its associated message;
sending measurement indications generated during the test event to a control node.

3. A method according to claim 2, characterized by performing the test event in response to a triggering message from the control node

4. A method according to claim 3, characterized by receiving content data blocks for test messages from the control node.

5. A method according to claim 3, characterized by
storing service logic of the interactive application service;
generating content data blocks for test messages in response to a triggering message from the control node.

6. A method according to claim 2, characterized by the measurement event having a defined period and a measurement indication of a test event indicating whether at least one associated message was identified for the test message within the defined period.

7. A method according to claim 6, characterized by
determining for a test event a ratio between the number of test messages for which an associated message was identified and the number of test messages transmitted;
using ratio for evaluation of the current overall performance of the defined interactive application service.

8. A method according to claim 2, characterized by
extracting timestamp of the test message;
extracting timestamp of the associated message;
generating a measurement indication indicating the period between the timestamp of the test message and the timestamp of the associated message.

9. A method according to claim 2, characterized by
storing a second matching criterion applicable for determining a level of compliance between two sets of data blocks;
extracting content data blocks of the test message;
extracting content data blocks of the associated message:
using the second matching criterion to determine the level of compliance between content data blocks of the test message and content data blocks of the associated message;
generating the measurement indication that indicates the determined level of compliance.

10. A method according to claim 9, characterized in that the level of compliance between corresponding data blocks varies depending on the type of information carried in the data block.

11. A method according to claim 2, characterized by including in the measurement indication metadata that relates to the present test task.

12. A test apparatus, comprising an interface unit for communicating over a non-realtime messaging service and a processing unit, configured to provide means for performing steps of claim 1.

13. A control apparatus, comprising an interface for communicating with one or more terminal nodes, configured to provide means for
receiving a first terminal node a request for measuring current overall performance of a defined interactive application service in which information is exchanged over a non-realtime messaging service;
generating a test event corresponding to the received request a test, a test event comprising one or more test tasks, one test task including sending of a test message and generation of a measurement indication based a reply message associated to the test message;
initiating the test event by transmitting a triggering message to a second terminal node;
receiving one or more measurement indications from the second terminal node;
using the measurement indications to generate a measurement result;
sending the measurement result to the first terminal node.

14. A control apparatus according to claim 13, characterized by being configured to provide means for:
determining content of test messages of the test event;
determining content of expected reply messages, the relationship between the content of the expected reply message and the content of the test message corresponding directly with service logic of the defined interactive application service;
including the determined contents in the triggering message.

15. A system comprising a test apparatus according to claim 12 and a control apparatus, said control apparatus comprising an interface for communicating with one or more terminal nodes, and configured to provide means for
receiving a first terminal node a request for measuring current overall performance of a defined interactive application service in which information is exchanged over a non-realtime messaging service;
generating a test event corresponding to the received request a test, a test event comprising one or more test tasks, one test task including sending of a test message and generation of a measurement indication based a reply message associated to the test message;
initiating the test event by transmitting a triggering message to a second terminal node;
receiving one or more measurement indications from the second terminal node;
using the measurement indications to generate a measurement result;
sending the measurement result to the first terminal node.

16. A computer program product, readable by a computer and encoding instructions for executing a method of claim 1 in a test apparatus.
